(19) United States
(12) Patent Application Publication
(10) Pub. No.: US 2022/0338496 A1
(43) Pub. Date: Oct. 27, 2022

(54) OAT-BASED LIQUID HAVING ENHANCED FOAMING AND WELL-BALANCED TASTE QUALITY PROPERTIES, AND IMMUNOMODULATORY EFFICACY, PROCESS FOR PREPARING THE SAME BY QUADRI-ENZYME HYDROLYSIS AND USE OF THE SAME

(71) Applicant: A.G.V. PRODUCTS CORP., CHIAYI (TW)

(72) Inventors: Kwan-Han CHEN, CHIAYI (TW); HUNG-CHI HSIAO, CHIAYI (TW); CHUN-LIANG CHOU, CHIAYI (TW); HAI-FENG CHANG, CHIAYI (TW); YI-SHIAN WANG, CHIAYI (TW); YUN-WEN CHEN, CHIAYI (TW); PEI-HSIU HUANG, CHIAYI (TW); PEI-CHEN HSIEH, CHIAYI (TW)

(21) Appl. No.: 17/726,010

(22) Filed: Apr. 21, 2022

(30) Foreign Application Priority Data
Apr. 23, 2021 (TW) 110114772

(51) Int. Cl. A23C 11/10; A23L 2/39; A23L 2/52; A23L 7/104; A23L 33/00; A23J 3/34

(52) U.S. Cl. CPC A23C 11/10; A23L 2/39; A23L 2/52; A23L 7/107; A23L 33/00; A23J 3/34; C12Y 302/01002; C12Y 302/01033

(57) ABSTRACT

The present invention relates to an oligo-saccharide oat liquid composition, an oligo-saccharide oat powder composition and an oligo-saccharide oat drink having improved properties and immunomodulatory efficacy (for example, promotion of proliferation of immune cells), a micro-milling process involving quadri-enzyme hydrolysis for preparing the same, and uses thereof.

### BACKGROUND OF THE INVENTION

### 1. Field of the Invention

The present invention relates to an oligo-saccharide oat liquid composition, an oligo-saccharide oat powder composition and a micronized oligo-saccharide oat drink having improved properties and immunomodulatory efficacy (for example, promotion of proliferation of immune cells), methods for preparing the same by micro-milling and quadri-enzyme hydrolysis, and uses thereof.

### 2. Description of the Related Art

It is the norm for modern people to drink coffee. In order to add flavor and nutritive value, people may choose lattes with milk products. However, lactose contained in animal milks may cause discomfort in, for example, the gastrointestinal tract of patients with lactose intolerance. Moreover, consumers who avoid animal milks due to religious or personal reasons may not be able to drink lattes. Therefore, people in the industry have been trying to find alternative foods to meet this demand.

For example, U.S. Pat. No. 4,996,063 discloses a method for making water-soluble dietary fiber by hydrolyzing oats with α-amylase. The powdery dietary fiber prepared by the method may be used as a food additive to serve as a fat substitute.

U.S. Pat. No. 5,686,123 discloses a homogeneous and stable cereal suspension and a method of making the same. U.S. Pat. No. 6,451,369 discloses a non-dairy ready-to-use milk substitute and products made therewith. Chinese Patent No. 1566161 discloses a preparation method of oat β-glucan. Although these preparation methods of water-soluble dietary fiber disclosed in the prior art can obtain oat β-glucan at high yield, the processing steps are complex and the enzyme treatment time is long, thereby causing high production costs. Additionally, products obtained by certain methods disclosed in the prior art have lost the natural fragrance of oats, and thus cannot provide people with the flavor and feeling of having natural oats.

In addition to the oat β-glucan, isomaltooligosaccharide is known to be able to lower intestinal pH, promote intestinal peristalsis, inhibit proliferation of harmful bacteria and reduce toxic waste produced by the metabolism of harmful bacteria, and has the efficacies of protecting the internal environment and enhancing the human body functions. Taiwan Patent No. TW 1441600 discloses a method for preparing an oligo-saccharide oat drink by micro-milling and tri-enzyme hydrolysis, including: adding β-amylase to a milled oat slurry, followed by adding α-amylase and trans-glucosidase to carry out enzyme treatment on the milled oat slurry, thereby obtaining the oat drink containing rich functional ingredients.

There are also methods for improving product texture in the prior art. For example, US 2019/0110501 A1 discloses a process for producing a non-dairy food product, which involves crosslinking of glutamine and lysine units of a protein isolate by means of transglutaminase to increase the viscosity of the product. CN 102016057 A discloses a method of denaturing a protein with glutaminase and transglutaminase to improve the texture of protein-containing food.

In addition, with the prevalence of various emerging diseases, such as COVID-19, in addition to relying on the development of the pharmaceutical industry, providing different aspects of protection from the perspective of preventive medicine may provide favorable support for the prevention and treatment of diseases. Therefore, there is a potential and non-negligible need to enhance autoimmunity. Such plant-based dairy products have the potential to enhance immunity, and there is a real need for continued research and development.

However, there is still a need in the field for oat compositions and drinks which have better liquid uniformity, foaming capacity, stability and emulsifying capacity, contain rich functional ingredients such as β-glucan and isomaltooligosaccharide and have the effect of enhancing immunity.

### SUMMARY OF THE INVENTION

The present invention provides an oligo-saccharide oat liquid composition, an oligo-saccharide oat powder composition and a micronized oligo-saccharide oat drink having improved properties and immunomodulatory efficacy (for example, promotion of proliferation of immune cells), and methods for preparing the same by micro-milling and quadri-enzyme hydrolysis. According to the methods, oats are dried and micro-milled, and then dissolved in water to form an oat raw material slurry, and then, α-amylase, β-amylase, transglutaminase and transglucosidase are added for carrying out enzyme treatment so as to obtain the oat products containing rich functional ingredients and having improved properties. By using the aforementioned methods, complete nutrients of whole oats can be retained, and the filtration operation is avoided, which is beneficial to improve the utilization rate of the raw material. In addition, multi-stage enzymatic hydrolysis is completed under the optimized short-time enzyme reaction and enzyme inactivation conditions. This step can avoid potential rancidification of the materials during the processing of the oat slurry. The products prepared by the above-mentioned methods not only completely retain the oat β-glucan but also have a higher content of isomaltooligosaccharide ingredients than that in common oat products. The products also have improved liquid uniformity, foaming capacity, stability and emulsifying capacity, and thus can be a substitute for milk and used for plant milk frothing.

Accordingly, the present invention provides a preparation method using the combination of micro-milling and enzyme hydrolysis. The method includes: milling oats to obtain micronized oat powder, and then carrying out a two-stage enzyme treatment with β-amylase and transglucosidase, and α-amylase and transglutaminase, thereby obtaining the novel, improved oligo-saccharide oat liquid composition, oligo-saccharide oat powder composition and micronized oligo-saccharide oat drink that have liquid uniformity, foaming capacity, stability and emulsifying capacity and contain rich functional ingredients such as β-glucan and isomaltooligosaccharide.

The present invention also relates to an oligo-saccharide oat liquid composition prepared by the method according to the present invention. The present invention also relates to an oligo-saccharide oat powder composition prepared by the method according to the present invention. The present invention also relates to a micronized oligo-saccharide oat drink, which comprises the oligo-saccharide oat liquid composition or the oligo-saccharide oat powder composition prepared by the method according to the present invention.

The present invention also relates to uses of the oligo-saccharide oat liquid composition, the oligo-saccharide oat powder composition or the micronized oligo-saccharide oat drink described above as a milk substitute.

The present invention also relates to uses of the oligo-saccharide oat liquid composition, the oligo-saccharide oat powder composition or the micronized oligo-saccharide oat drink described above as a base of ice cream, oatmeal, yogurt, health drinks, flavored cereal drinks or snack food.

The present invention also relates to uses of the oligo-saccharide oat liquid composition, the oligo-saccharide oat powder composition or the micronized oligo-saccharide oat drink described above for preparing healthy food for modulating immunity.

The present invention also relates to a healthy food, which comprises the oligo-saccharide oat liquid composition, the oligo-saccharide oat powder composition or the micronized oligo-saccharide oat drink of the present invention.

The present invention also relates to uses of the oligo-saccharide oat liquid composition, the oligo-saccharide oat powder composition, the micronized oligo-saccharide oat drink or the healthy food described above for modulating immunity.

The present invention also relates to a method for modulating immunity, including: administering the oligo-saccharide oat liquid composition, the oligo-saccharide oat powder composition, the micronized oligo-saccharide oat drink or the healthy food of the present invention to a subject in need.

### DETAILED DESCRIPTION OF THE PRESENT INVENTION

In one embodiment, the present invention provides a method of preparing an oligo-saccharide oat liquid composition having improved properties and immunomodulatory efficacy (for example, promotion of proliferation of immune cells) with micro-milling and quadri-enzyme hydrolysis, comprising: micro-milling and carrying out hydrolysis with β-amylase, transglucosidase, α-amylase and transglutaminase on an oat raw material to provide the oligo-saccharide oat liquid composition. The micro-milling and hydrolysis is carried out in two stages: the β-amylase and the transglucosidase are used in the first stage, and the α-amylase and the transglutaminase are used in the second stage.

In one embodiment, the method with micro-milling and hydrolysis according of the present invention comprises the following steps:
(1) providing oats as a raw material, milling the raw material to form micronized powder with an average particle size of less than about 100 μm, and dissolving or dispersing the micronized powder in an aqueous medium to form a raw material slurry;
(2) adding β-amylase and transglucosidase into the raw material slurry to carry out a first-stage enzyme reaction until a viscosity of the raw material slurry of about 0.5 to about 0.1 Pas is reached, thereby obtaining a first-stage hydrolyzed raw material slurry;
(3) adding α-amylase and transglutaminase to the first-stage hydrolyzed raw material slurry to carry out a second-stage enzyme reaction until a viscosity of the raw material slurry of about 0.05 to about 0.01 Pas is reached, thereby obtaining a second-stage hydrolyzed raw material slurry;
(4) heating the second-stage hydrolyzed raw material slurry to inactivate the enzymes, and then lowering the temperature; and
(5) carrying out ultra-high temperature (UHT) instantaneous sterilization on the raw material slurry in step (4) to provide an oligo-saccharide oat liquid composition.

The raw material used in step (1) includes oats, including, but not limited to, oats from various origins, and various types of oat-containing substances, such as whole grain oats, steel-cut oats, rolled oats, instant oats, oatmeal, oat flour, oat flour containing bran, etc.

In step (1), the raw material is milled to form the micronized powder with the average particle size of less than about 100 preferably less than about 75 and the micronized powder is then dissolved or dispersed in an aqueous medium to form the raw material slurry. In one embodiment, the aqueous medium includes water, preferably deionized water.

Next, two-stage enzyme treatment is carried out on the raw material slurry obtained in step (1). In one embodiment, the two-stage enzyme treatment is carried out by conducting step (2) and step (3). In step (2), the β-amylase and the transglucosidase are added into the raw material slurry, and the first-stage enzyme reaction is carried out until the viscosity of the raw material slurry reaches about 0.5 to about 0.1 Pas, preferably less than about 0.3 Pas, thereby obtaining a first-stage hydrolyzed raw material slurry. In step (3), the α-amylase and the transglutaminase are added into the first-stage hydrolyzed raw material slurry, and the second-stage enzyme reaction is carried out until the viscosity of the raw material slurry reaches about 0.05 to about 0.01 Pas, preferably less than about 0.03 Pas, thereby obtaining a second-stage hydrolyzed raw material slurry.

According to one embodiment of the present invention, the β-amylase is derived from plants or microorganisms such as bacteria or fungi. The plant-derived β-amylase is derived from barley, wheat, sweet potato, etc., but is not limited thereto. The microorganism-derived β-amylase is derived from Bacillus polymyxa, Bacillus cereus, Bacillus megaterium, Bacillus polymyxa, Clostridium thermosulfurogenes, Aspergillus oryzae, Aspergillus niger, etc., but is not limited thereto. The α-amylase is derived from plants or microorganisms such as bacteria or fungi. The plant-derived α-amylase is derived from corn, sorghum, barley, etc., but is not limited thereto. The microorganism-derived α-amylase is derived from Bacillus licheniformis, Bacillus stearothermophilus, Bacillus amyloliquefaciens, Bacillus subtilis, Bacillus dipsosauri, Haloarcula hispanica, Halomonas meridiana, Aspergillus oryzae, Aspergillus niger, Thermomyces lanuginosus, etc., but is not limited thereto. The transglucosidase is derived from microorganisms such as bacteria or fungi. The microorganism-derived transglucosidase is derived from Debaryomyces hansenii, Talaromyces duponti, Aspergillus niger, etc., but is not limited thereto. The transglutaminase is derived from plants or microorganisms such as bacteria or fungi. The plant-derived transglutaminase is derived from soybean, Jerusalem artichoke, etc., but is not limited thereto. The microorganism-derived transglutaminase is derived from Bacillus circulans, Streptoverticillium mobaraense, Streptomyces platensis, Streptomyces lividans, Streptomyces lydicus, Streptomyces platensis, Streptomyces sioyansis, Streptoverticillium griseocarneum, Streptoverticillium ladakanum, etc., but is not limited thereto. All the enzymes above are available from commercial methods or manufacturers such as AMANO™, DuPont™ SternEnzym™ or Novozymes™.

As understood by persons of ordinary skill in the art of the present invention, the amounts of enzymes added, operating temperature and operating time during the enzyme treatment are affected by many factors, such as the raw material used, the enzyme added, the viscosity of the final product, etc. Persons of ordinary skill in the art can optimize the operating conditions of the enzyme treatment according to the desired properties of the product.

According to one embodiment of the present invention, in the first-stage enzyme reaction, the amounts of the β-amylase and the transglucosidase added each independently, based on the weight of the raw material slurry, ranges from about 0.1 to 1.0% (w/w), preferably from about 0.2 to 0.5% (w/w), and the operating temperature is about 40° C. to 70° C., preferably about 50 to 65° C.

According to one embodiment of the present invention, in the second-stage enzyme reaction, the amounts of the α-amylase and the transglutaminase added each independently, based on the weight of the raw material slurry, ranges from about 0.1 to 1.0% (w/w), preferably from about 0.2 to 0.5% (w/w), and the operating temperature is about 40° C. to 70° C., preferably about 50 to 65° C.

It takes about 0.5 to 2 hours, preferably about 0.5 to 1 hour, to complete the entire two-stage enzyme treatment.

After the above-stated two-stage enzyme treatment is completed, step (4) is then carried out, i.e., the obtained hydrolyzed raw material slurry is heated to inactivate the enzymes, followed by lowering the temperature. According to one embodiment of the present invention, enzyme inactivation is carried out at a temperature of about 85 to 95° C., preferably about 90° C., for about 1 to 3 minutes, preferably about 2 minutes, and then the temperature is lowered to about 50 to 70° C. Next, in step (5) of the method according to the present invention, the product obtained after the enzyme inactivation is subjected to ultra-high temperature (UHT) instantaneous sterilization (at about 130 to 140° C.; for 10 to 60 seconds), thereby obtaining an oligo-saccharide oat liquid composition.

According to one embodiment of the present invention, the obtained final product may optionally be further packaged by an aseptic cool filling system, or the final product may be directly used as a substitute for milk to prepare a plant milk latte drink.

Whilst not being bound by theory, the method of the present invention at least has the following characteristics:

(1) By using the two-stage enzyme reaction, the reaction procedure can be optimized, and optimally, the reaction time can be shortened to only about 0.5 to 1 hour, so that the processing time and the labor cost are greatly reduced.

(2) By combining with the aseptic cool filling system, the storage life of the product at room temperature can be extended for up to 12 months.

(3) After the raw material slurry is treated by the transglutaminase, the processing characteristics (foaming capacity, stability and emulsifying capacity) of protein in the product can be enhanced, so the product can be applied to the plant milk latte drink.

In addition to the above advantages of the process, oat particles contained in the oligo-saccharide oat liquid composition prepared by the method according to the present invention have an average particle size of about 30 μm or less, preferably about 20 μm or less, and oat particles contained in the micronized oligo-saccharide oat drink obtained which is subjected to a further treatment (for example, homogenization) have an average particle size of about 20 μm or less, preferably about 10 μm or less, so the product can be directly introduced into a packaging container without a filtration step, thereby retaining complete nutrients of whole grains.

In another aspect, the enzyme treatment process of the method of the present invention can produce not only β-glucan but also isomaltooligosaccharide, the content of which is more than 3 times that in cereal oatmeal, so that the protein bonding is more stable, and the oat slurry has good foaming capacity and stability and emulsifying capacity comparable to milk.

In one embodiment, the present invention provides a method for preparing an oligo-saccharide oat powder composition, including: carrying out the steps for preparing the oligo-saccharide oat liquid composition according to any one of the aforementioned methods and a step of processing the oligo-saccharide oat liquid composition obtained by the above steps by a drying process, thereby preparing the oligo-saccharide oat powder composition. In one embodiment, the present invention provides an oligo-saccharide oat powder composition prepared by the aforementioned method for preparing an oligo-saccharide oat powder composition.

According to one embodiment of the present invention, the drying process includes, but is not limited to, drum drying, lyophilization, spray drying and other processing techniques known to persons of ordinary skill in the art of the present invention. The drum drying is to dry solution-like, slurry-like, mud-like, dehydrated block-like or dispersion-like materials into powdery, sheet-like or film-like materials, preferably into powdery materials. The lyophilization involves a procedure of converting ice into water vapor. Generally speaking, water in solid state (ice) is converted into water in gas state (water vapor) via melting (a phase change from solid to liquid) followed by gasification (a phase change from liquid to gas). However, by properly changing the temperature or pressure, solid water may be directly converted into gaseous water via sublimation (a phase change from solid to gas). For example, in a low-temperature and high-vacuum environment, the purpose of drying can be achieved by directly converting frozen and condensed water in a substance into water vapor to remove the water content therefrom via sublimation. The spray drying is achieved by using a spray dryer which delivers heated and purified air into the spray dryer body by an air drawing and blowing mechanism, in combination with a high-speed rotating spray head which nebulizes a liquid substance such as a solution or a paste that is pumped therein into extremely small droplets, such that water content in the droplets is instantly taken away when the air contacts with the droplets and the solid content is collected by a collector, thereby achieving the purpose of direct drying.

In one embodiment of the present invention, the oligo-saccharide oat powder composition provided by the present invention is instant food powder, which is food-grade and can be directly used in food, for example, as a raw material for brewable powder or health food. The oligo-saccharide oat powder composition prepared in this manner has the fragrance of oats and allows the user to have a more pronounced smell/taste sensation.

The oligo-saccharide oat liquid composition prepared by the method according to the present invention contains rich β-glucan, isomaltooligosaccharide and total protein contents, comprising, based on the weight of the oligo-saccharide oat liquid composition, at least about 0.2% (w/w), preferably about 0.2% to 0.8% (w/w), more preferably about 0.3% to 0.7% (w/w) of β-glucan, and at least about 0.5% (w/w), preferably about 0.5% to 3% (w/w), more preferably about 1.0% to 2.5% (w/w) of isomaltooligosaccharide.

Animal experiments have been conducted to provide evidence that the oligo-saccharide oat liquid composition, the oligo-saccharide oat powder composition and the micronized oligo-saccharide oat drink provided by the present invention are beneficial for promoting proliferation of immune cells, enhancing the viabilities of phagocytes and natural killer cells, increasing the secretion of immune cell cytokines IL-2 and IFN-γ, inhibiting the production of Th2 allergen reaction-specific IgG1 and IgE antibodies in serum, and increasing the production of the OVA-specific IgG2a antibody in serum, and therefore, have the health-care efficacy of modulating non-specific and specific immunity. As such, the oligo-saccharide oat liquid composition, the oligo-saccharide oat powder composition and the micronized oligo-saccharide oat drink provided by the present invention have potential in exhibiting immunomodulatory effects and thereby in maintaining health and even protecting against emerging diseases.

In addition, the oligo-saccharide oat liquid composition, the oligo-saccharide oat powder composition and the micronized oligo-saccharide oat drink provided by the present invention not only preserve the natural flavor of oats, but also have the mellowness and smoothness similar to those of milk as well as foaming capacity, stability and emulsifying capacity comparable to those of milk, and therefore, can be used as a substitute for milk and are especially suitable for patients with lactose intolerance. The oligo-saccharide oat liquid composition, the oligo-saccharide oat powder composition and the micronized oligo-saccharide oat drink provided by the present invention may also be used as a base of ice cream, oatmeal, yogurt, milk shakes, health drinks or snack food, or further made into flavored cereal drinks by adding ingredients such as red beans, peanuts, honey, etc. According to the present invention, the traditional way of eating oats has changed, and the nutritional and health care values of processed oat products are greatly increased.

The following examples are used to further illustrate concepts of the present invention but are not intended to limit the scope of the present invention. Any modifications and changes that can be readily achieved by persons of ordinary skill in the art shall fall within the scope of the contents in the specification of the present invention and the appended claims.

### EXAMPLES

### Example 1

### Process Technology:

(a) Oat was used as a raw material and milled by a dry ball mill to give micronized oat powder (with an average particle size of about 100 to 75 um).

(b) The oat powder was dissolved in water (10 to 25% (w/w); pH 5 to 8), and the mixture was heated and stirred for 10 to 15 minutes (at a temperature of 50 to 60° C.) to obtain a raw material slurry.

(c) The raw material slurry was subjected to enzyme treatment: 0.2 to 0.5% (w/w) of β-amylase and 0.2 to 0.5% (w/w) of transglucosidase were added to carry out an enzyme reaction (at a temperature of 50 to 65° C.). When a viscosity of the hydrolyzed raw material slurry reached less than about 0.5 to 0.1 Pas, 0.2 to 0.5% (w/w) of α-amylase and 0.2 to 0.5% (w/w) of transglutaminase were added to carry out an enzyme reaction (at a temperature of 50 to 65° C.) until the viscosity of the hydrolyzed raw material slurry reached less than about 0.05 to 0.01 Pas. It took about 0.5 to 1 hour to complete the entire enzyme treatment.

(d) The hydrolyzed raw material slurry in step (c) was heated to inactivate the enzymes for 2 minutes (at a temperature of 90° C.), and then the temperature was lowered to 50 to 70° C.

(e) The hydrolyzed raw material slurry in step (d) was subjected to ultra-high temperature (UHT) instantaneous sterilization (at a temperature of 140° C. for 30 seconds) and an aseptic cool filling system procedure to give an oligo-saccharide oat liquid composition containing rich β-glucan (about 0.4% (w/w)) and isomaltooligosaccharide (about 2.0% (w/w)).

(f) The oligo-saccharide oat liquid composition in step (e), containing oat particles with an average particle size of about 30 μm or less, might be further processed into a micronized oligo-saccharide oat drink; or the oligo-saccharide oat liquid composition in step (e) might be further dried to give an oligo-saccharide oat powder composition.

(g) One or more of the oligo-saccharide oat liquid composition, the oligo-saccharide oat powder composition and the micronized oligo-saccharide oat drink in step (f) might be used as a substitute for milk to prepare plant milk lattes for people having a special need (for example, patients with lactose intolerance).

(h) Food additives, such as canola oil, sodium chloride, calcium phosphate, calcium carbonate and dipotassium hydrogen phosphate, might be added to the plant milk lattes in step (g) to further prepare a product with smooth texture and good palatability.

### Example 2

Oat slurries were prepared according to three different processes and further made into latte drinks, which were tested for their constitution and properties.

Experimental group I: Two-stage enzyme treatment was carried out according to Taiwan Patent No. TW 1441600.

Experimental group II: Two-stage enzyme treatment was carried out according to the method of the present invention.

Experimental group III: Two-stage enzyme treatment was carried out by using β-amylase for the first stage and α-amylase for the second stage.

Preparation procedure of latte drinks: about 30 g of liquid coffee concentrate was mixed with about 300 g of the oat slurries of experimental group I, experimental group II or experimental group III, and the mixtures were foamed by a commercially available foaming machine. The resulting products were allowed to stand for 90 minutes and tested for their foam height at a specified time.

Foaming capacity evaluation criteria: height of foam from the liquid surface at a standing time of 0 minutes.

Stability evaluation criteria: Changes of foam height at a standing time of 30, 60 and 90 minutes.

Emulsifying capacity evaluation criteria: The standing time at which marbling and/or separation of layers occurred. Marbling and separation of layers indicate possible changes in protein structure or properties.

Preference: 10 subjects were subjected to blind testing to evaluate the flavor of the drinks after taking the drinks of the three groups.

TABLE 1
Compositions and properties of oat slurries obtained by different processes

| | Oat slurry | | | | | | | |
|---|---|---|---|---|---|---|---|---|
| | | Total | | | Total | Free | | |
| | Hydrolysis | isomalto- | | | protein | amino | Particle | |
| Group | time | oligosaccharide | | β-glucan | content | acid | size | Viscosity |
| I | 1.5~2 hr. | 16.18 | mg/g | 0.656 | 2.0 | 262.92 | 27.50 | 57 cps |
| | | | | g/100 ml | g/100 g | | | |
| II | 1~1.5 hr. | 13.67 | mg/g | 0.622 | 1.95 | 272.77 | 25.55 | 26 cps |
| | | | | g/100 ml | g/100 g | | | |
| III | 1.5~2 hr. | 8 | mg/g | 0.575 | 1.66 | 228.62 | 50.67 | 23 cps |
| | | | | g/100 ml | g/100 g | | | |

TABLE 2
Properties of latte drinks obtained by different processes

| | Latte drink | | | | |
|---|---|---|---|---|---|
| | | Foaming | Stability | | |
| | Emulsifying | capacity | After 30 | After 60 | After 90 |
| Group | capacity | 0 minute | minutes | minutes | minutes |
| I | 6 minutes | 3 cm | 2.7 cm | 2 cm | 1.4 cm |
| II | None* | 4.7 cm | 3.9 cm | 3.2 cm | 2.8 cm |
| III | 25 minutes | 4.6 cm | 3.6 cm | 2.8 cm | 2.4 cm |

| | Subjective score | |
|---|---|---|
| Group | (out of 10) | Description of flavor |
| I | 1 | The texture is rich but with granules, which |
| | | is very different from the texture of common |
| | | milk lattes. |
| II | 9 | The texture is smooth andrich, with a blend |
| | | of aroma and thickness in the middle, which |
| | | is similar to the texture of common milk |
| | | lattes. |
| III | 4 | The texture is fresh and light and relatively |
| | | far from a milk texture. |

*No marbling or separation of layers occurred after 90 minutes of standing.

As can be seen from the above results, the total isomaltooligosaccharide, the β-glucan, the total protein content and the free amino acid content in the oligo-saccharide oat liquid composition prepared by the method provided by the present invention were significantly higher than those in the most traditional di-enzyme process (experimental group III), and comparable to those in the tri-enzyme process (experimental group I). In terms of physical properties, the particle size was significantly lower than that in the most traditional di-enzyme process and comparable to that in the tri-enzyme process, and the viscosity was comparable to that in the di-enzyme process and significantly lower than that in the tri-enzyme process. The improvement of these physical properties was beneficial to the subsequent process.

With regard to the physical properties of the prepared latte drinks, the oat latte drink provided by the present invention had higher comprehensive evaluation of the foaming capacity, foam stability and emulsifying capacity than that of the other two latte drinks, and thus, had significant advantages when being stored and used as a plant-based milk product. Specifically, in terms of foaming capacity, the foaming capacity of is the oat latte drink provided by the present invention was significantly better than that of the oat latte drink prepared by the tri-enzyme process, and comparable to that of the oat latte drink prepared by the di-enzyme process. In terms of stability, the foam stability of the oat latte drink provided by the present invention was significantly better than that of the oat latte drink prepared by the tri-enzyme process. The foaming capacity and the foam stability helped to provide the latte drinks with excellent texture. In terms of emulsifying capacity, no marbling or separation of layers occurred to the oat latte drink provided by the present invention within 90 minutes of the test time, which indicated the advantage in long-term storage; it also exhibits good texture and blending of flavor. The subjective score by consumers also demonstrated the excellent effects of the present invention.

### Example 3

Immunomodulatory efficacy of oligo-saccharide oat liquid composition

### (1) Non-Specificity

This test was conducted mainly to investigate the non-specific immunomodulatory efficacy of the oligo-saccharide oat liquid composition of the present invention. During the entire test period, the test animals exhibited normal changes of body weight; the test animals in all groups grew stably without symptoms such as hair loss, declined activity, etc. The results of this test showed that the tested substances had the abilities to promote proliferation of immune cells and enhance the viabilities of phagocytes and natural killer cells; they also had the abilities to increase the secretion of immune cell cytokines IL-2 and IFN-γ and decrease the secretion of IL-4 and IL-5 under the stimulation of kinetin; and they also had the abilities to increase the level of immunoglobulin IgG in serum and decrease the level of immunoglobulin IgE in serum (see, Table 3). Based on the above, the oligo-saccharide oat liquid composition, the oligo-saccharide oat powder composition and the micronized oligo-saccharide oat drink of the present invention had the efficacy of modulating non-specific immunity.

TABLE 3
Summary of results of non-specific immunomodulatory test

| | | | Group | | |
|---|---|---|---|---|---|
| | | | Low | Medium | High |
| Test item | | | dose | dose | dose |
| Proliferation ability of | | ConA | p < 0.05↑ | p < 0.05↑ | p < 0.05↑ |
| immune cells | | LPS | p < 0.05↑ | p < 0.05↑ | p < 0.05↑ |
| Secretion | IL-2 | ConA | — | p < 0.05↑ | p < 0.05↑ |
| function of | | LPS | — | p < 0.05↑ | p < 0.05↑ |
| cytokine | IL-4 | ConA | p < 0.05↓ | p < 0.05↓ | p < 0.05↓ |
| | | LPS | p < 0.05↓ | p < 0.05↓ | p < 0.05↓ |
| | IL-5 | ConA | — | p < 0.05↓ | p < 0.05↓ |
| | | LPS | p < 0.05↓ | p < 0.05↓ | p < 0.05↓ |
| | TNF-α | ConA | — | — | — |
| | | LPS | — | — | — |
| | IFN-γ | ConA | p < 0.05↑ | p < 0.05↑ | p < 0.05↑ |
| | | LPS | — | p < 0.05↑ | p < 0.05↑ |
| Lymphocyte | T4 cells | | — | — | — |
| subset | T8 cells | | — | — | — |
| analysis | T cells | | — | — | — |
| | B cells | | — | — | — |
| | NK cells | | — | — | — |
| Serum | IgG | | p < 0.05↑ | p < 0.05↑ | p < 0.05↑ |
| antibody | IgM | | — | — | — |
| production | IgA | | — | — | — |
| | IgE | | p < 0.05↓ | p < 0.05↓ | p < 0.05↓ |
| Natural killer | E/T Ratio = | | p < 0.05↑ | p < 0.05↑ | p < 0.05↑ |
| cell viability | 5:1 | | | | |
| | E/T Ratio = | | p < 0.05↑ | p < 0.05↑ | p < 0.05↑ |
| | 10:1 | | | | |
| | E/T Ratio = | | p < 0.05↑ | p < 0.05↑ | p < 0.05↑ |
| | 25:1 | | | | |
| Peritoneal | M.O.I. = | | — | p < 0.05↑ | p < 0.05↑ |
| phagocyte | 12.5 | | | | |
| viability | M.O.I. = | | p < 0.05↑ | p < 0.05↑ | p < 0.05↑ |
| | 25 | | | | |
| | M.O.I. = | | p < 0.05↑ | p < 0.05↑ | p < 0.05↑ |
| | 50 | | | | |

—: the symbol represents there is no significant difference as compared with the negative control group; p < 0.05 means there is a significantly different increase or a significantly different decrease as compared with the negative control group.

### (2) Specificity

This test was conducted to investigate the effect of the oligo-saccharide oat liquid composition of the present invention on the specific immunity modulation in the model of ovalbumin (OVA) sensitized mice. The test substances were orally administrated to the test mice at doses of 3.8 g/kg (low dose group), 7.7 g/kg (medium dose group) or 15.4 g/kg (high dose group) for 8 consecutive weeks, and the changes in the level of OVA-specific antibodies in serum, the proliferation ability of spleen immune cells, the cytokine secretion volume, the spleen immune cell population and other indicators were measured to evaluate the specific immunomodulatory efficacy of the test substances. During the test period, the test animals exhibited normal changes of body weight and grew stably without symptoms such as hair loss, declined activity, etc., and the spleen weight/body weight ratio did not change in all the groups of OVA sensitized mice. The results of this test showed that the oligo-saccharide oat liquid composition of the present invention may promote proliferation of immune cells, increase the level of the serum antibody anti-OVA IgG2a and decrease the levels of the serum antibodies anti-OVA IgG1 and anti-OVA IgE; may increase the secretion of immune cell cytokines IL-2 and IFN-γ under the stimulation of ConA or OVA; and may decrease the secretion of IL-4, IL-5 and TNF-α (see, Table 4). Based on the above, the oligo-saccharide oat liquid composition, the oligo-saccharide oat powder composition and the micronized oligo-saccharide oat drink of the present invention had the efficacy of modulating specific immunity.

TABLE 4
Summary of results of specific immunomodulatory test

| | | | Low | Medium | High |
|---|---|---|---|---|---|
| Test item | | | dose | dose | dose |
| Proliferation ability of | | ConA | p < 0.05↑ | p < 0.05↑ | p < 0.05↑ |
| immune cells | | LPS | — | p < 0.05↑ | p < 0.05↑ |
| | | OVA | — | p < 0.05↑ | p < 0.05↑ |
| Secretion | IL-2 | ConA | p < 0.05↑ | p < 0.05↑ | p < 0.05↑ |
| function of | | LPS | p < 0.05↑ | p < 0.05↑ | p < 0.05↑ |
| cytokine | | OVA | p < 0.05↑ | p < 0.05↑ | p < 0.05↑ |
| | IL-4 | ConA | — | — | — |
| | | LPS | p < 0.05↓ | p < 0.05↓ | p < 0.05↓ |
| | | OVA | — | — | — |
| | IL-5 | ConA | — | p < 0.05↓ | p < 0.05↓ |
| | | LPS | — | — | — |
| | | OVA | p < 0.05↓ | p < 0.05↓ | p < 0.05↓ |
| | TNF-α | ConA | — | p < 0.05↓ | p < 0.05↓ |
| | | LPS | — | p < 0.05↓ | p < 0.05↓ |
| | | OVA | p < 0.05↓ | p < 0.05↓ | p < 0.05↓ |
| | IFN-γ | ConA | p < 0.05↑ | p < 0.05↑ | p < 0.05↑ |
| | | LPS | — | — | — |
| | | OVA | — | — | p < 0.05↑ |
| Lymphocyte | T4 cells | | — | — | — |
| subset | T8 cells | | — | — | — |
| analysis | T cells | | — | — | — |
| | B cells | | — | — | — |
| | NK cells | | — | — | — |
| Serum | Anti-OVA- | | p < 0.05↓ | p < 0.05↓ | p < 0.05↓ |
| antibody | IgG1 | | | | |
| production | Anti-OVA- | | p < 0.05↑ | p < 0.05↑ | p < 0.05↑ |
| | IgG2a | | | | |
| | Anti-OVA- | | p < 0.05↓ | p < 0.05↓ | p < 0.05↓ |
| | IgE | | | | |

—: the symbole represents there is no significant difference as compared with the negative control group; p < 0.05: means there is a significantly different increase or a significantly different decrease as compared with the negative control group.

The results of the above animal tests may serve as evidence that the oligo-saccharide oat liquid composition, the oligo-saccharide oat powder composition and the micronized oligo-saccharide oat drink of the present invention can modulate immunity, including promoting proliferation of immune cells, enhancing the viabilities of phagocytes and natural killer cells, etc.

1. A method for preparing an oligo-saccharide oat liquid composition, comprising carrying out micro-milling and two-stage enzyme hydrolysis on an oat raw material to provide the oligo-saccharide oat liquid composition, wherein β-amylase and transglucosidase are used in the first stage, and α-amylase and transglutaminase are used in the second stage.

2. The method according to claim 1, comprising the following steps:
(1) providing oats as a raw material, milling the raw material to form micronized powder with an average particle size of less than about 100 and dissolving or dispersing the micronized powder in an aqueous medium to form a raw material slurry;
(2) adding β-amylase and transglucosidase to the raw material slurry to carry out a first-stage enzyme reaction until a viscosity of the raw material slurry reaches about 0.5 to about 0.1 Pas, thereby obtaining a first-stage hydrolyzed raw material slurry;
(3) adding α-amylase and transglutaminase to the first-stage hydrolyzed raw material slurry to carry out a second-stage enzyme reaction until a viscosity of the raw material slurry reaches about 0.05 to about 0.01 Pas, thereby obtaining a second-stage hydrolyzed raw material slurry;
(4) heating the second-stage hydrolyzed raw material slurry to inactivate the enzymes, and then lowering the temperature; and
(5) carrying out ultra-high temperature (UHT) instantaneous sterilization on the raw material slurry in step (4) to provide the oligo-saccharide oat liquid composition.

3. The method according to claim 2, wherein the aqueous medium in step (1) comprises deionized water.

4. The method according to claim 2, wherein the raw material slurry in step (1) has a pH of at least about 5 to 8.

5. The method according to claim 1, wherein amounts of the α-amylase, the β-amylase, the transglucosidase and the transglutaminase added each independently ranges from about 0.1 to 1.0% (w/w), and an operating temperature of the enzyme treatment is about 40° C. to about 70° C.

6. The method according to claim 2, further comprising step (6): packaging the oligo-saccharide oat liquid composition by an aseptic cool filling system.

7. An oligo-saccharide oat liquid composition, which is obtained by the method according to claim 1.

8. A method for preparing an oligo-saccharide oat powder composition, comprising the following steps:
(a) preparing an oligo-saccharide oat liquid composition by the method according to claim 1, and
(b) processing the oligo-saccharide oat liquid composition prepared in step (a) by a drying process to prepare the oligo-saccharide oat powder composition.

9. An oligo-saccharide oat powder composition, which is obtained by the method according to claim 8.

10. A micronized oligo-saccharide oat drink, comprising the oligo-saccharide oat liquid composition according to claim 7.

11. The micronized oligo-saccharide oat drink according to claim 10, wherein oat particles comprised therein have an average particle size of about 30 μm or below.

12. A method of making a food, comprising a step of using the oligo-saccharide oat liquid composition according to claim 7 as a milk substitute ingredient in the food.

13. A method of making ice cream, oatmeal, yogurt, health drinks, flavored cereal drinks or snack food, comprising a step of using the oligo-saccharide oat liquid composition according to claim 7 as a base thereof.

14. A method of preparing healthy food for modulating immunity, comprising a step of using the oligo-saccharide oat liquid composition according to claim 7 as an ingredient thereof.

15. The method according to claim 14, wherein the immunity is selected from the group consisting of non-specific immunity and specific immunity.

16. A healthy food, comprising the oligo-saccharide oat liquid composition according to claim 7.

17. A micronized oligo-saccharide oat drink, comprising the oligo-saccharide oat powder composition according to claim 9.

18. A healthy food, comprising the oligo-saccharide oat powder composition according to claim 9.

19. A healthy food, comprising the micronized oligo-saccharide oat drink according to claim 10.

20. A healthy food, comprising the micronized oligo-saccharide oat drink according to claim 17.
